(19) United States
(12) Patent Application Publication
(10) Pub. No.: US 2026/0210269 A1
(43) Pub. Date: Jul. 23, 2026

(54) TURBOCHARGER HOUSING AND TURBOCHARGER

(71) Applicant: MITSUBISHI HEAVY INDUSTRIES ENGINE & TURBOCHARGER, LTD., Sagamihara-shi, Kanagawa (JP)

(72) Inventors: Shuichi MIURA, Tokyo (JP); Akihiro SUGIYAMA, Sagamihara-shi (JP); Jun SUZUKI, Sagamihara-shi (JP); Takaya FUTAE, Tokyo (JP); Yusuke FURUTA, Sagamihara-shi (JP); Takuya ARAKAWA, Tokyo (JP)

(73) Assignee: MITSUBISHI HEAVY INDUSTRIES ENGINE & TURBOCHARGER, LTD., Sagamihara-shi, Kanagawa (JP)

(21) Appl. No.: 19/142,897

(22) PCT Filed: Jan. 13, 2023
(86) PCT No.: PCT/JP2023/000702

§ 371 Date: Jun. 24, 2025

(51) Int. Cl. F01D 25/04; F01D 25/24

(52) U.S. Cl. CPC F01D 25/04; F01D 25/243; F05D 2220/40

(57) ABSTRACT

This turbocharger housing is provided with: a compressor housing having a first communication hole; a bearing housing having a second communication hole; a first joining part provided in the compressor housing, extending along the outside of the first communication hole in a circumferential direction; a second joining part provided in the bearing housing, extending along the outside of the second communication hole in the circumferential direction; a first fastening member fastening the first joining part and the second joining part together, and at least one annular first plate member provided in at least one of the first joining part and the second joining part by the first fastening member to be slidable with respect to at least one of the first joining part and the second joining part.

### TECHNICAL FIELD

The present disclosure relates to a turbocharger housing and a turbocharger.

### BACKGROUND ART

A turbocharger for improving an output of an engine can be mounted on an engine used in an automobile or the like. A turbocharger, which is a rotary machine, may generate vibration during operation, and there is a problem of noise caused by the vibration.

PTL 1 discloses a turbine housing that can improve the rigidity of the entire outer cylinder and can reduce the amplitude of the outer cylinder. In the turbine housing, at least one reinforcing plate material is fixed to an inner surface of each of a plurality of thin plate members by welding at at least one point.

### CITATION LIST

### Patent Literature

[PTL 1] Japanese Unexamined Patent Application Publication No. 2016-180310

### SUMMARY OF INVENTION

### Technical Problem

According to the study of the present inventors, it has been found that the vibration of the turbocharger housing can be effectively suppressed by applying friction to the turbocharger housing.

The present disclosure has been made in view of the above-described circumstances, and an object of the present disclosure is to provide a turbocharger housing and a turbocharger capable of suppressing vibration.

### Solution to Problem

In order to achieve the above object, a turbocharger housing according to the present disclosure includes: a compressor housing in which a first communication hole is formed; a bearing housing in which a second communication hole is formed; a first connection part provided in the compressor housing to extend along an outer side in a circumferential direction of the first communication hole; a second connection part provided in the bearing housing to extend along an outer side in a circumferential direction of the second communication hole; a first fastening member that fastens the first connection part and the second connection part to each other; and at least one annular first plate member that is provided on at least one of the first connection part or the second connection part by the first fastening member to be slidable relative to at least one of the first connection part or the second connection part.

### Advantageous Effects of Invention

According to the turbocharger housing of the present disclosure, the at least one annular first plate member is provided on at least one of the first connection part or the second connection part by the first fastening member to be slidable relative to at least one of the first connection part or the second connection part. Therefore, in a case where vibration occurs in the compressor housing or the bearing housing, the first plate member slides relative to the first connection part or the second connection part, and friction occurs, so that the vibration of the turbocharger housing is damped, and thus the vibration of the turbocharger can be suppressed.

### BRIEF DESCRIPTION OF DRAWINGS

FIG. 1 is a schematic configuration view schematically showing an overall configuration of a turbocharger including a turbocharger housing according to an embodiment of the present disclosure.

FIG. 2A is a schematic cross-sectional view including a first connection part of a turbocharger housing according to a first embodiment of the present disclosure.

FIG. 2B is a schematic cross-sectional view including a second connection part of the turbocharger housing according to the first embodiment of the present disclosure.

FIG. 3 is an enlarged cross-sectional view showing an enlarged first connection part and an enlarged second connection part of the turbocharger housing according to the first embodiment of the present disclosure.

FIG. 4 is an enlarged cross-sectional view showing a first connection part and a second connection part of a turbocharger housing according to a modification example of the first embodiment of the present disclosure in an enlarged manner.

FIG. 5 is an enlarged cross-sectional view showing a first connection part and a second connection part of a turbocharger housing according to a modification example of the first embodiment of the present disclosure in an enlarged manner.

FIG. 6 is an enlarged cross-sectional view showing a first connection part and a second connection part of a turbocharger housing according to a modification example of the first embodiment of the present disclosure in an enlarged manner.

FIG. 7A is a schematic cross-sectional view including a third connection part of a turbocharger housing according to a second embodiment of the present disclosure.

FIG. 7B is a schematic cross-sectional view including a fourth connection part of a turbocharger housing according to the second embodiment of the present disclosure.

FIG. 8 is an enlarged cross-sectional view showing a third connection part and a fourth connection part of the turbocharger housing according to the second embodiment of the present disclosure in an enlarged manner.

FIG. 9 is an enlarged cross-sectional view showing a third connection part and a fourth connection part of a turbocharger housing according to a modification example of the second embodiment of the present disclosure in an enlarged manner.

FIG. 10 is an enlarged cross-sectional view showing a third connection part and a fourth connection part of a turbocharger housing according to a modification example of the second embodiment of the present disclosure in an enlarged manner.

FIG. 11 is an enlarged cross-sectional view showing a third connection part and a fourth connection part of a turbocharger housing according to a modification example of the second embodiment of the present disclosure in an enlarged manner.

FIG. 12 is a schematic view of a compressor housing according to a third embodiment of the present disclosure.

FIG. 13 is an enlarged cross-sectional view showing an outlet pipe for a turbocharger housing according to the third embodiment of the present disclosure in an enlarged manner.

FIG. 14 is an enlarged cross-sectional view showing an outlet pipe for a turbocharger housing according to a modification example of the third embodiment of the present disclosure in an enlarged manner.

FIG. 15 is a schematic view of a compressor housing according to a fourth embodiment of the present disclosure.

FIG. 16 is an enlarged cross-sectional view showing an outlet pipe for a turbocharger housing according to a fifth embodiment of the present disclosure in an enlarged manner.

FIG. 17 is an enlarged cross-sectional view showing an annular portion of the turbocharger housing according to the fifth embodiment of the present disclosure in an enlarged manner.

FIG. 18 is an enlarged cross-sectional view showing an outer ring member of the turbocharger housing according to the fifth embodiment of the present disclosure in an enlarged manner.

### DESCRIPTION OF EMBODIMENTS

Hereinafter, a turbocharger housing according to an embodiment of the present disclosure will be described with reference to the drawings. The embodiments which will be described below show aspects of the present disclosure and do not limit the disclosure, and any change can be made within the scope of the technical idea of the present disclosure.

### Turbocharger

### <Configuration of Turbocharger of Present Disclosure>

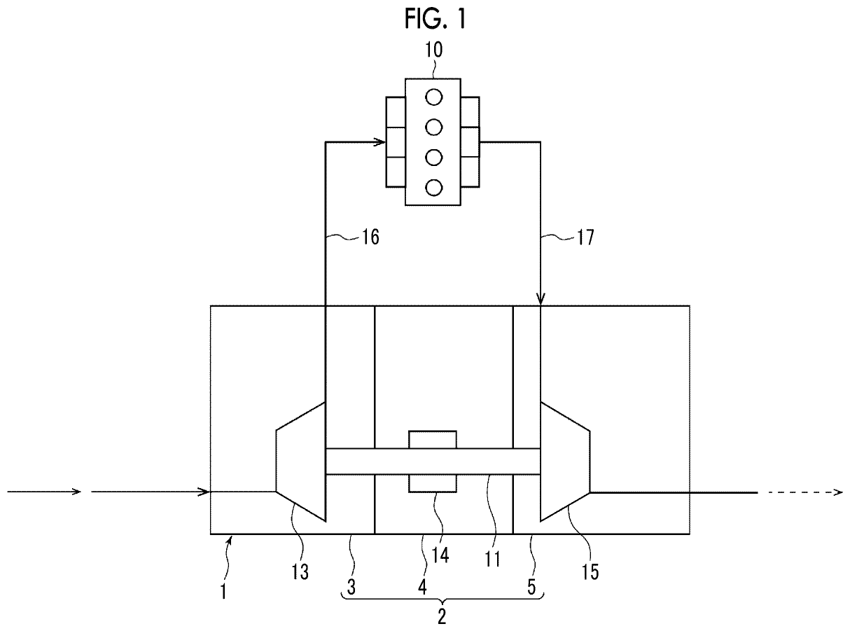

As shown in FIG. 1, a turbocharger 1 according to some embodiments of the present disclosure includes a turbocharger housing 2. The turbocharger housing 2 includes a compressor housing 3, a bearing housing 4, and a turbine housing 5. An impeller 13 is rotatably accommodated in the compressor housing 3. The impeller 13 is provided in an intake air channel 16 through which combustion gas sent to an engine 10 flows. A bearing 14 that rotatably supports a shaft 11 is accommodated in the bearing housing 4. A turbine rotor 15 connected to the impeller 13 via the shaft 11 is rotatably accommodated in the turbine housing 5. The turbine rotor 15 is provided in an exhaust channel 17 for discharging exhaust gas generated from the engine 10.

### First Embodiment

### <Configuration of Turbocharger Housing According to First Embodiment of Present Disclosure>

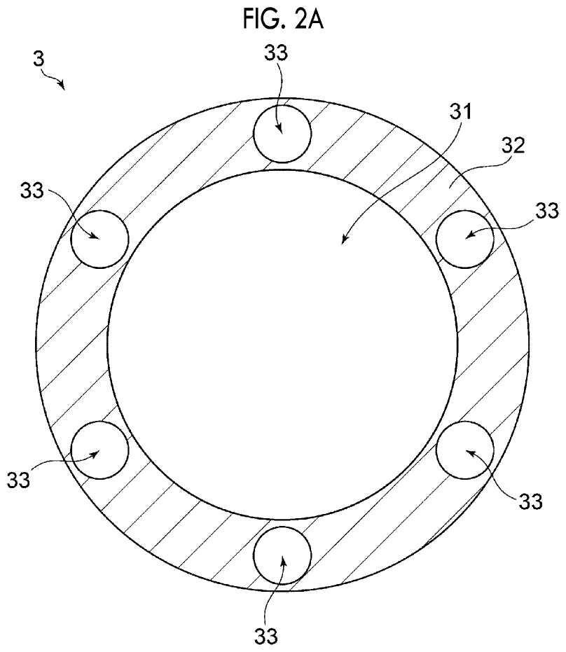

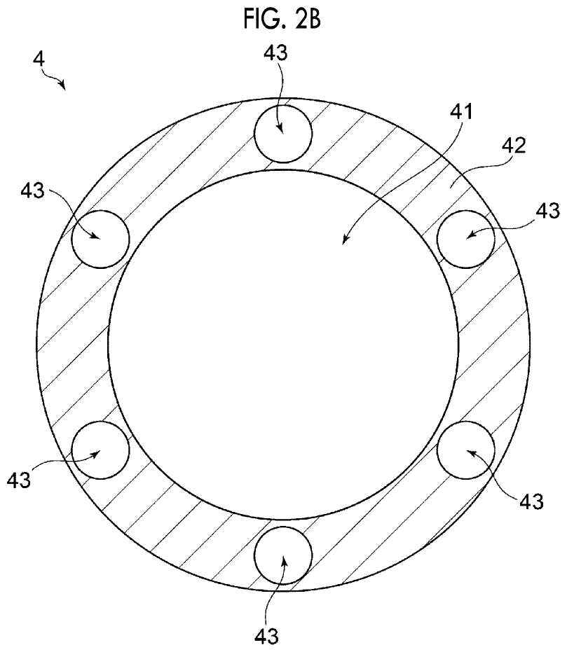

As shown in FIG. 2A, a first communication hole 31 is formed in the compressor housing 3. A first connection part 32 extending along a circumferential direction of the first communication hole 31 is provided on an outer side of the first communication hole 31 in the circumferential direction. In the illustrated embodiment, the first connection part 32 is provided in an annular shape. A plurality of holes 33 for inserting bolts are formed in the first connection part 32 at intervals in the circumferential direction. The intervals in the circumferential direction may be equal intervals or may be different intervals. The first connection part 32 can be configured as, for example, a flange.

As shown in FIG. 2B, a second communication hole 41 is formed in the bearing housing 4. A second connection part 42 extending along a circumferential direction of the second communication hole 41 is provided on an outer side of the second communication hole 41 in the circumferential direction. In the illustrated embodiment, the second connection part 42 is provided in an annular shape. A plurality of holes 43 for inserting bolts are formed in the second connection part 42 at intervals in the circumferential direction. The intervals in the circumferential direction may be equal intervals or may be different intervals. The second connection part 42 can be configured as, for example, a flange.

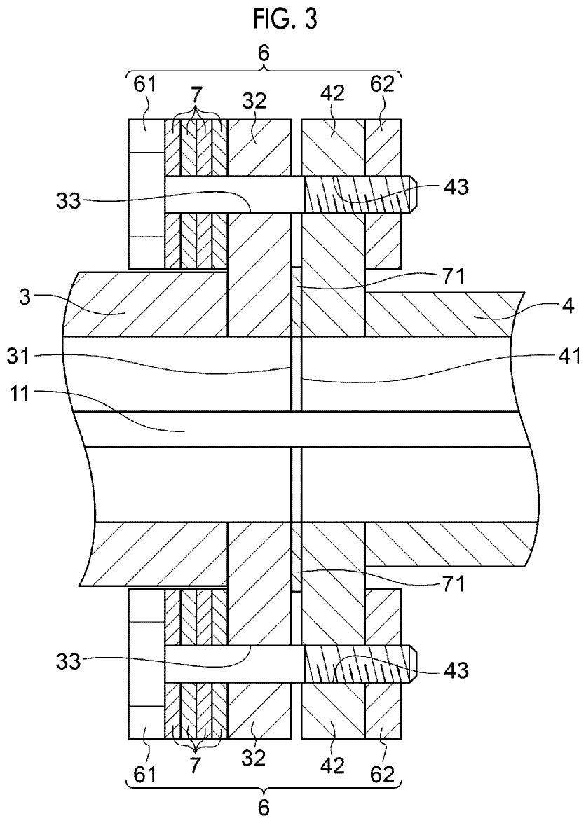

As shown in FIG. 3, the first connection part 32 and the second connection part 42 are fastened by a first fastening member 6 in a state of facing each other such that the first communication hole 31 and the second communication hole 41 communicate with each other. The first fastening member 6 may include, for example, a bolt 61 and a nut 62. The bolts 61 are inserted into the holes 33 and 43, and the first connection part 32 and the second connection part 42 are fastened using the nuts 62. In addition, the shaft 11 is configured to penetrate the first communication hole 31 and the second communication hole 41.

In the first embodiment, in the first connection part 32, four annular first plate members 7 are provided by the first fastening member 6 to be slidable relative to the first connection part 32. That is, the four first plate members 7 having an annular shape are provided to be laminated to be slidable relative to the first connection part 32 on a side opposite to the second connection part 42 with respect to the first connection part 32. The first plate members 7 adjacent to each other are provided to be slidable relative to each other. In the first embodiment, a case where four first plate members 7 are provided to be laminated will be described. However, the number of the first plate members 7 may be one or any number of two or more.

When the fastening of the first fastening member 6 is stronger than a predetermined value, the first plate member 7 is not slidable relative to the first connection part 32. Therefore, the first plate member 7 can be provided to be slidable relative to the first connection part 32 by making the fastening of the first fastening member 6 weaker than a predetermined value.

On the other hand, in a case where the fastening of the first fastening member 6 is weaker than a predetermined value, there is a possibility that gas leakage occurs from the joined portions of the first connection part 32 and the second connection part 42. Therefore, it is necessary to appropriately fasten the first fastening member 6.

In addition, the turbocharger housing 2 may include a gasket 71 between the first connection part 32 and the second connection part 42. The gasket 71 may be provided along the circumferential direction of the first connection part 32 or the second connection part 42. By including the gasket 71, even when the fastening of the first fastening member 6 is weakened from a predetermined value, the sealing performance of the joined portion between the first connection part 32 and the second connection part 42 can be ensured.

### <Operation of Turbocharger According to First Embodiment of Present Disclosure>

Next, the operation of the turbocharger according to the first embodiment of the present disclosure will be described. The exhaust gas discharged from the engine 10 flows into the turbine housing 5 through the exhaust channel 17 and rotates the turbine rotor 15. The impeller 13 is connected to the turbine rotor 15 via the shaft 11, and thus rotates in conjunction with the rotation of the turbine rotor 15. The air introduced into the compressor housing 3 is compressed by the rotation of the impeller 13 and is sucked into a cylinder of the engine 10 through the intake air channel 16.

In the turbocharger 1 which is a rotary machine, vibration may occur during operation. According to the study of the present inventors, it has been found that the vibration of the turbocharger housing 2 can be effectively suppressed by adopting the above-described configuration for the turbocharger housing 2.

In a case where vibration occurs in the compressor housing 3 or the bearing housing 4, the first plate member 7 slides relative to the first connection part 32, and friction occurs between the first plate member 7 and the first connection part 32. In this manner, the vibration of the turbocharger housing 2 is damped, and thus the vibration of the turbocharger 1 can be suppressed.

In the first embodiment, since the plurality of first plate members 7 are provided in a laminated manner, the first plate members 7 adjacent to each other slide with each other, and friction occurs between the first plate members 7 adjacent to each other. On the other hand, in a case where one first plate member 7 is provided, only the friction between the first plate member 7 and the first connection part 32 occurs. Therefore, in a case where the plurality of first plate members 7 are provided in a laminated manner, the vibration damping effect due to the friction occurring between the first plate members 7 adjacent to each other is obtained as compared with a case where one first plate member 7 is provided. Therefore, the vibration of the turbocharger 1 can be further suppressed.

### <Modification Example of Turbocharger Housing According to First Embodiment of Present Disclosure>

In the first embodiment, the first plate member 7 is provided to be slidable relative to the first connection part 32 on a side opposite to the second connection part 42 with respect to the first connection part 32. However, the present disclosure is not limited to this embodiment.

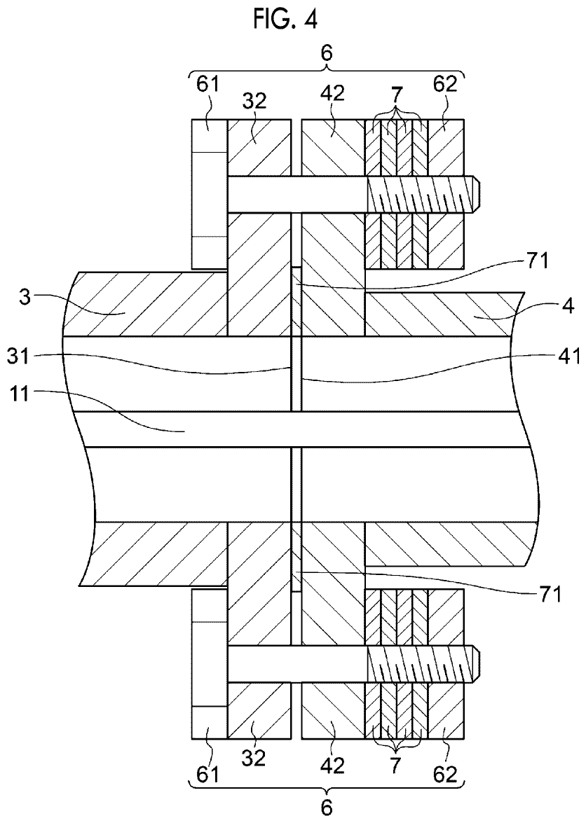

As shown in FIG. 4, four annular first plate members 7 are provided in the second connection part 42 by the first fastening member 6 to be slidable relative to the second connection part 42. That is, the four first plate members 7 having an annular shape are provided to be laminated to be slidable relative to the second connection part 42 on a side opposite to the first connection part 32 with respect to the second connection part 42. In the modification example described below, four first plate members 7 are provided to be laminated. However, the number of the first plate members 7 may be one or any number of two or more.

In a case where vibration occurs in the compressor housing 3 or the bearing housing 4, the first plate member 7 slides relative to the second connection part 42, and friction occurs between the first plate member 7 and the second connection part 42. In this manner, the vibration of the turbocharger housing 2 is damped, and thus the vibration of the turbocharger 1 can be suppressed.

The first plate member 7 may be provided on both a side opposite to the second connection part 42 with respect to the first connection part 32 and a side opposite to the first connection part 32 with respect to the second connection part 42. According to such a configuration, the area on which the first plate member 7 slides increases and the friction increases as compared with a case where the first plate member 7 is provided on the side opposite to the second connection part 42 with respect to the first connection part 32 or on one side opposite to the first connection part 32 with respect to the second connection part 42. Therefore, the vibration of the turbocharger housing 2 is further damped. As a result, the vibration of the turbocharger 1 can be further suppressed.

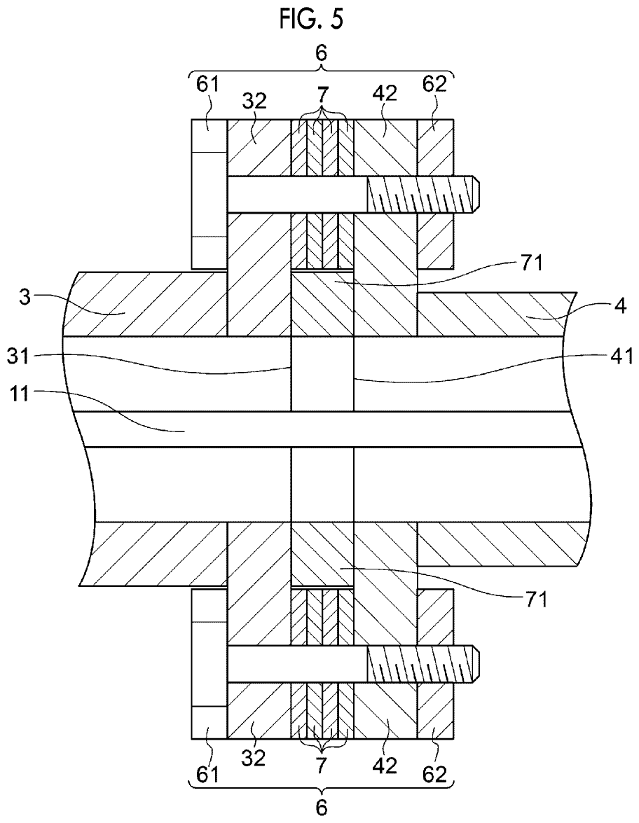

As shown in FIG. 5, four annular first plate members 7 are provided by the first fastening member 6 to be slidable relative to the first connection part 32 or the second connection part 42 between the first connection part 32 and the second connection part 42. In a case where the turbocharger housing 2 includes the gasket 71 between the first connection part 32 and the second connection part 42, the first plate member 7 may be provided along an outer side of the gasket 71 in the circumferential direction.

In a case where vibration occurs in the compressor housing 3 or the bearing housing 4, the first plate member 7 slides relative to the first connection part 32 or the second connection part 42, or both of the first connection part 32 and the second connection part 42, and friction occurs. In this manner, the vibration of the turbocharger housing 2 is damped, and thus the vibration of the turbocharger 1 can be suppressed.

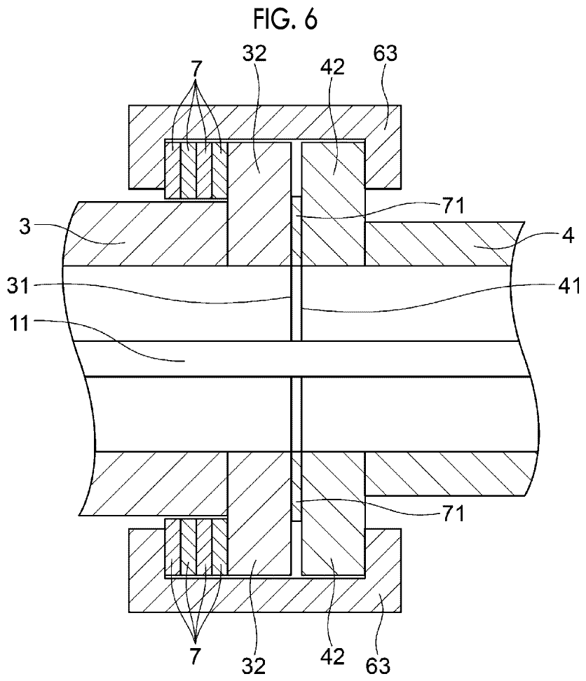

In the first embodiment, the first fastening member 6 is the bolt 61 and the nut 62, but the present disclosure is not limited thereto. For example, as shown in FIG. 6, the first fastening member 6 may be a V clamp 63 that is provided to sandwich peripheral edges of the first connection part 32 and the second connection part 42 in a state where the first connection part 32 and the second connection part 42 face each other.

### Second Embodiment

### <Configuration of Turbocharger Housing According to Second Embodiment of Present Disclosure>

The configuration according to the second embodiment can be added to the configuration of the first embodiment or can be an alternative form of the first embodiment.

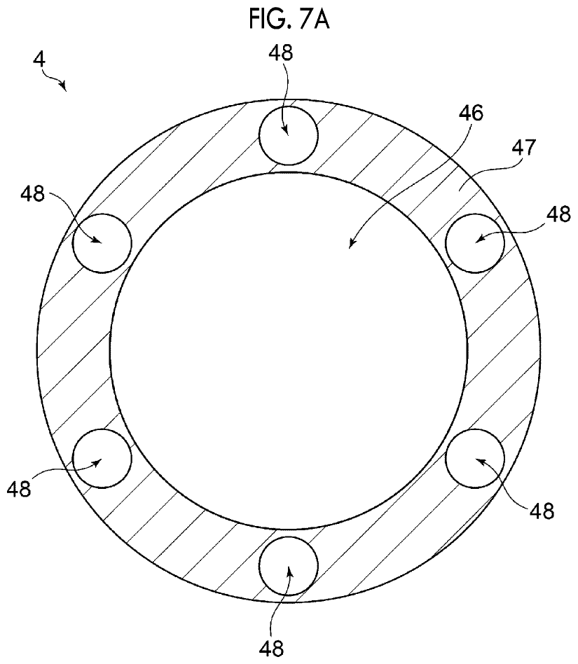

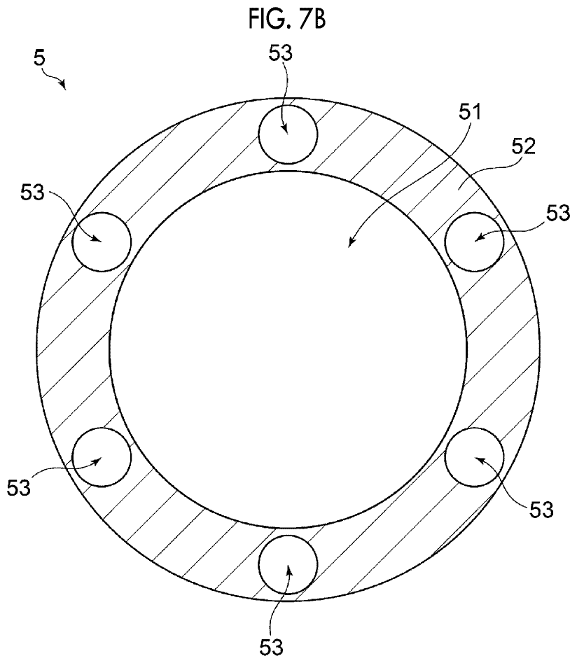

As shown in FIG. 7A, a third communication hole 46 is formed in the bearing housing 4. A third connection part 47 extending along a circumferential direction of the third communication hole 46 is provided on an outer side of the third communication hole 46 in the circumferential direction. In the illustrated embodiment, the third connection part 47 is provided in an annular shape. A plurality of holes 48 for inserting bolts are formed in the third connection part 47 at intervals in the circumferential direction. The intervals in the circumferential direction may be equal intervals or may be different intervals. The third connection part 47 can be configured as, for example, a flange.

As shown in FIG. 7B, a fourth communication hole 51 is formed in the turbine housing 5. A fourth connection part 52 extending along a circumferential direction of the fourth communication hole 51 is provided on an outer side of the fourth communication hole 51 in the circumferential direction. In the illustrated embodiment, the fourth connection part 52 is provided in an annular shape. A plurality of holes 53 for inserting bolts are formed in the fourth connection part 52 at intervals in the circumferential direction. The intervals in the circumferential direction may be equal intervals or may be different intervals. The fourth connection part 52 can be configured as, for example, a flange.

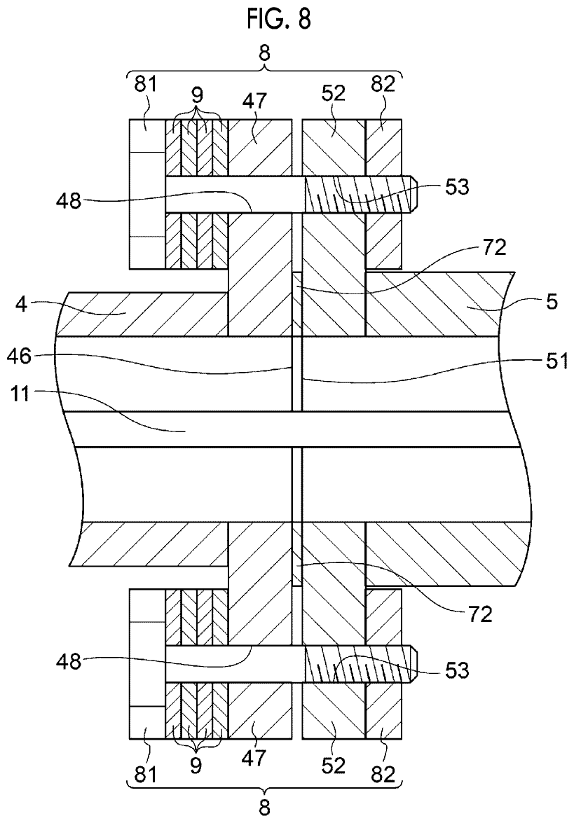

As shown in FIG. 8, the third communication hole 46 and the fourth communication hole 51 are fastened by the second fastening member 8 in a state where the third connection part 47 and the fourth connection part 52 face each other to communicate with each other. The second fastening member 8 may include, for example, a bolt 81 and a nut 82. The bolts 81 are inserted into the holes 48 and 53, and the third connection part 47 and the fourth connection part 52 are fastened using the nuts 82. In addition, the shaft 11 is configured to penetrate the third communication hole 46 and the fourth communication hole 51.

In the second embodiment, the four annular second plate members 9 are provided on the third connection part 47 by the second fastening member 8 to be slidable relative to the third connection part 47. That is, the four second plate members 9 having an annular shape are provided to be laminated to be slidable relative to the third connection part 47 on a side opposite to the fourth connection part 52 with respect to the third connection part 47. The second plate members 9 adjacent to each other are provided to be slidable relative to each other. In the second embodiment, a case where four second plate members 9 are provided to be laminated will be described. However, the number of the second plate members 9 may be one or any number of two or more.

When the fastening of the second fastening member 8 is stronger than a predetermined value, the second plate member 9 is not slidable relative to the third connection part 47. Therefore, by making the fastening of the second fastening member 8 weaker than a predetermined value, the second plate member 9 can be provided to be slidable relative to the third connection part 47.

On the other hand, in a case where the fastening of the second fastening member 8 is weaker than a predetermined value, there is a possibility that gas leakage occurs from the joined portions of the third connection part 47 and the fourth connection part 52. Therefore, it is necessary to appropriately fasten the second fastening member 8.

In addition, the turbocharger housing 2 may include a gasket 72 between the third connection part 47 and the fourth connection part 52. The gasket 72 may be provided along the circumferential direction of the third connection part 47 or the fourth connection part 52. By including the gasket 72, even when the fastening of the second fastening member 8 is made weaker than a predetermined value, the sealing performance of the joined portion between the third connection part 47 and the fourth connection part 52 can be ensured.

### <Operation of Turbocharger According to Second Embodiment of Present Disclosure>

Next, the operation of the turbocharger according to the second embodiment of the present disclosure will be described. The operation of the turbocharger 1 is the same as the operation described in the first embodiment. Therefore, vibration may also occur in the turbocharger 1 according to the second embodiment.

In a case where vibration occurs in the bearing housing 4 or the turbine housing 5, the second plate member 9 slides relative to the third connection part 47, and friction occurs between the second plate member 9 and the third connection part 47. In this manner, the vibration of the turbocharger housing 2 is damped, and thus the vibration of the turbocharger 1 can be suppressed.

In the second embodiment, since the plurality of second plate members 9 are provided to be laminated, the second plate members 9 adjacent to each other slide with each other, and friction occurs between the second plate members 9 adjacent to each other. On the other hand, in a case where one second plate member 9 is provided, friction only occurs between the second plate member 9 and the third connection part 47. Therefore, in a case where the plurality of second plate members 9 are provided to be laminated, the vibration damping effect due to the friction occurring between the second plate members 9 adjacent to each other is obtained as compared with a case where one second plate member 9 is provided. Therefore, the vibration of the turbocharger 1 can be further suppressed.

### <Modification Example of Turbocharger Housing According to Second Embodiment of Present Disclosure>

In the second embodiment, the second plate member 9 is provided to be slidable relative to the third connection part 47 on the side opposite to the fourth connection part 52 with respect to the third connection part 47. However, the present disclosure is not limited to this embodiment.

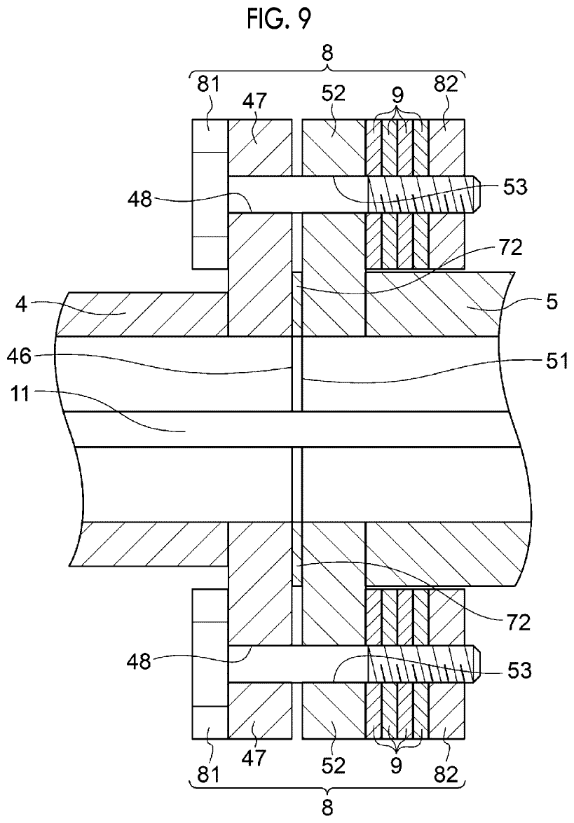

As shown in FIG. 9, four annular second plate members 9 are provided on the fourth connection part 52 by the second fastening member 8 to be slidable relative to the fourth connection part 52. That is, the four second plate members 9 having an annular shape are provided to be laminated to be slidable relative to the fourth connection part 52 on a side opposite to the third connection part 47 with respect to the fourth connection part 52. In the modification example described below, four first plate members 7 are provided to be laminated. However, the number of the first plate members 7 may be one or any number of two or more.

In a case where vibration occurs in the bearing housing 4 or the turbine housing 5, the second plate member 9 slides relative to the fourth connection part 52, and friction occurs between the second plate member 9 and the fourth connection part 52. In this manner, the vibration of the turbocharger housing 2 is damped. Therefore, the vibration of the turbocharger 1 can be suppressed.

The second plate member 9 may be provided on both sides opposite to the fourth connection part 52 with respect to the third connection part 47 and opposite to the third connection part 47 with respect to the fourth connection part 52. According to such a configuration, the area on which the second plate member 9 slides increases and the friction increases as compared with a case where the second plate member 9 is provided on the side opposite to the fourth connection part 52 with respect to the third connection part 47 or on one side opposite to the third connection part 47 with respect to the fourth connection part 52. Therefore, the vibration of the turbocharger housing 2 is further damped. As a result, the vibration of the turbocharger 1 can be further suppressed.

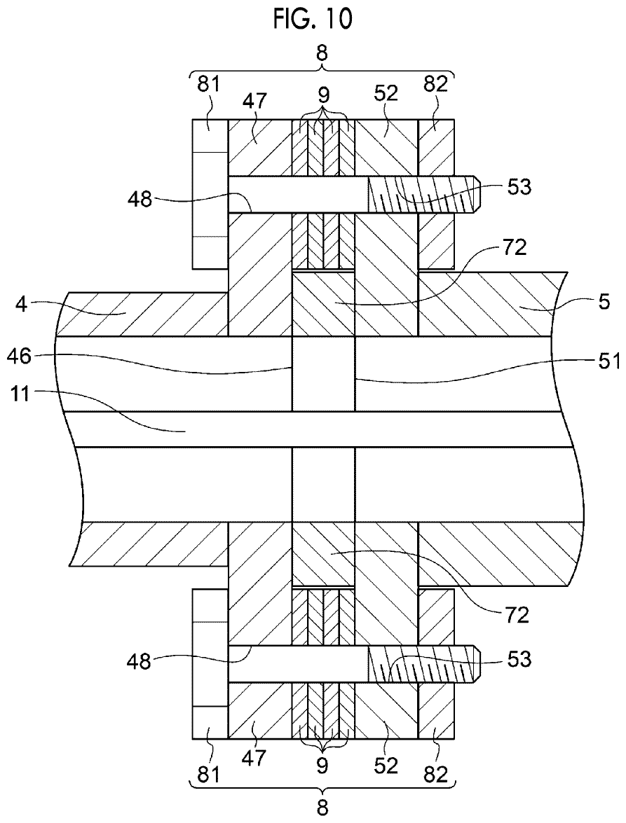

As shown in FIG. 10, four annular second plate members 9 are provided between the third connection part 47 and the fourth connection part 52 by the second fastening member 8 to be slidable relative to the third connection part 47 or the fourth connection part 52. In a case where the turbocharger housing 2 includes the gasket 72 between the third connection part 47 and the fourth connection part 52, the second plate member 9 may be provided along the outer side of the gasket 72 in the circumferential direction.

In a case where vibration occurs in the bearing housing 4 or the turbine housing 5, the second plate member 9 slides relative to the third connection part 47 or the fourth connection part 52, or both of the third connection part 47 and the fourth connection part 52, and friction occurs, so that the vibration of the turbocharger housing 2 is damped. Therefore, the vibration of the turbocharger 1 can be suppressed.

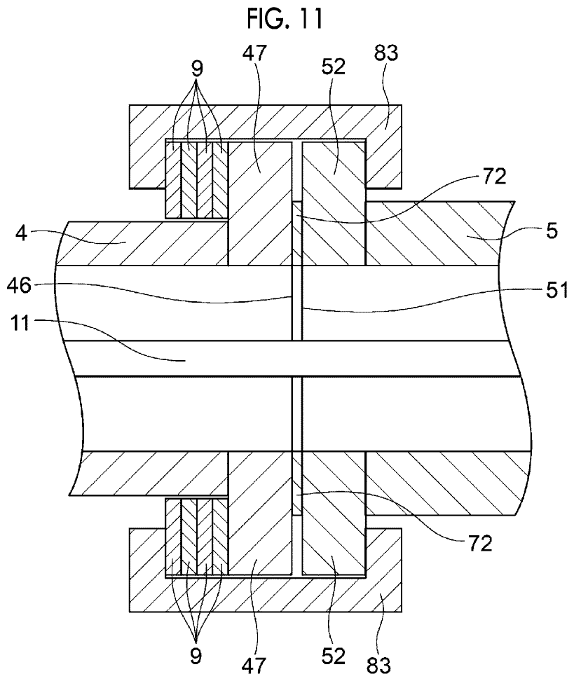

In the second embodiment, the second fastening member 8 is the bolt 81 and the nut 82, but the present disclosure is not limited thereto. For example, as shown in FIG. 11, the second fastening member 8 may be a V clamp 83 that is provided to sandwich peripheral edges of the third connection part 47 and the fourth connection part 52 in a state where the third connection part 47 and the fourth connection part 52 face each other.

### Third Embodiment

### <Configuration of Turbocharger Housing According to Third Embodiment of Present Disclosure>

The configuration according to the third embodiment can be added to the configuration of the first embodiment or can be an alternative form of the first embodiment. In addition, the configuration according to the third embodiment can be added to the configuration of the second embodiment or can be an alternative form of the second embodiment.

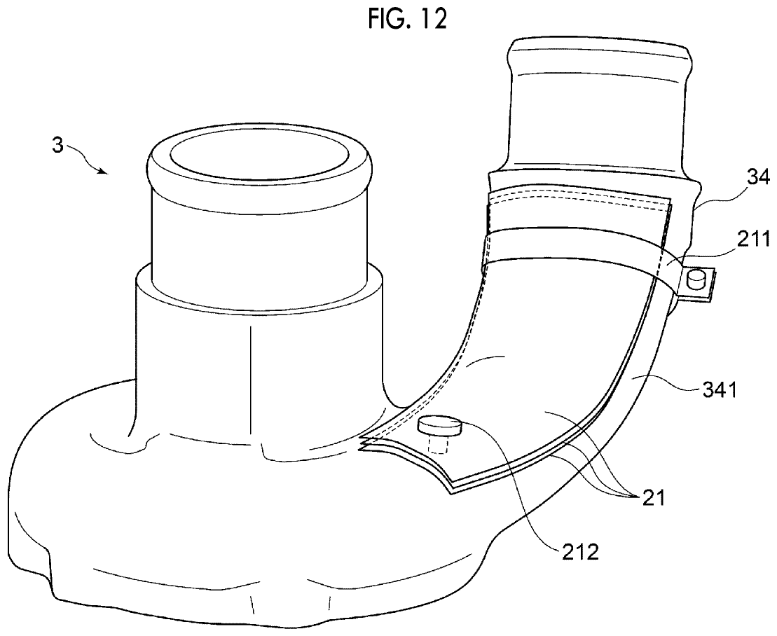

As shown in FIG. 12, the compressor housing 3 includes an outlet pipe 34 for discharging the compressed air. A thin plate 21 is provided in the compressor housing 3.

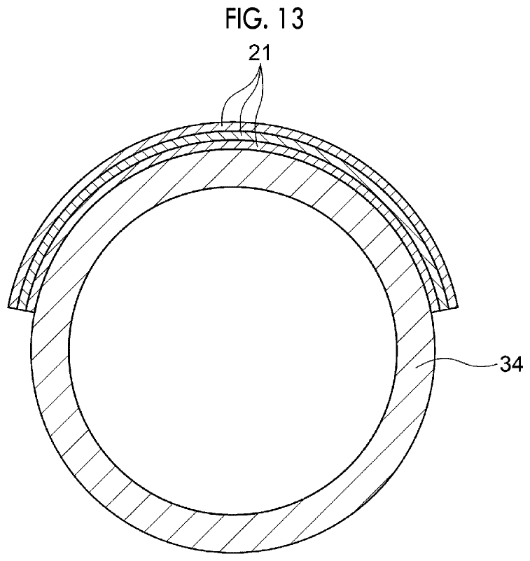

In the third embodiment, three thin plates 21 are provided at two locations of each of the outlet pipe 34 and another portion by a fastening member 211 and a fastening member 212 to be slidable relative to the compressor housing 3. In the third embodiment, a band is used as the fastening member 211, and a bolt is used as the fastening member 212. As shown in FIG. 13, the three thin plates 21 are provided to extend along an outer peripheral surface 341 of the outlet pipe 34, and are provided to cover a part of the outer peripheral surface 341 of the outlet pipe 34 in the circumferential direction. That is, the three thin plates 21 are provided to be laminated to be slidable relative to the compressor housing 3. The thin plates 21 adjacent to each other are provided to be slidable relative to each other. In the third embodiment, a case where three thin plates 21 are provided in a laminated manner will be described. However, the number of the thin plates 21 may be one or any number of two or more.

In the third embodiment, a band is used as the fastening member 211 and a bolt is used as the fastening member 212, but the present disclosure is not limited thereto. For example, the fastening member 211 may be a bolt, the fastening member 212 may be a band, and the fastening members 211 and 212 may be bands. In addition, any fastening member, such as a pin, can be used instead of the band or the bolt.

When the fastening of the fastening members 211 and 212 is stronger than a predetermined value, the thin plate 21 is not slidable relative to the compressor housing 3. Therefore, by making the fastening of the fastening members 211 and 212 weaker than a predetermined value, the thin plate 21 can be provided to be slidable relative to the compressor housing 3.

### <Operation of Turbocharger According to Third Embodiment of Present Disclosure>

Next, the operation of the turbocharger according to the third embodiment of the present disclosure will be described. The operation of the turbocharger 1 is the same as the operation described in the first embodiment. Therefore, vibration may also occur in the turbocharger 1 according to the third embodiment.

In a case where vibration occurs in the turbocharger 1, the thin plate 21 slides relative to the compressor housing 3, and friction occurs, so that the vibration of the turbocharger housing 2 is damped. Therefore, the vibration of the turbocharger 1 can be suppressed.

In the third embodiment, since the plurality of thin plates 21 are provided in a laminated manner, the adjacent thin plates 21 slide relative to each other, and friction occurs between the adjacent thin plates 21. On the other hand, in a case where one thin plate 21 is provided, friction only occurs between the thin plate 21 and the compressor housing 3. Therefore, in a case where the plurality of thin plates 21 are provided in a laminated manner, the vibration damping effect due to friction occurring between the thin plates 21 adjacent to each other is obtained as compared with a case where one thin plate 21 is provided. Therefore, the vibration of the turbocharger 1 can be further suppressed.

The turbocharger 1 is provided with a thin plate 21 extending along the outer peripheral surface 341 of the outlet pipe 34. Therefore, the vibration of the turbocharger housing 2 is further damped by increasing the contact area between the thin plate 21 and the compressor housing 3, and thus the vibration of the turbocharger 1 can be further suppressed.

### <Modification Example of Turbocharger Housing According to Third Embodiment of Present Disclosure>

In the third embodiment, the thin plate 21 is provided to cover a part of the outer peripheral surface 341 of the outlet pipe 34 in the circumferential direction. However, the present disclosure is not limited to this embodiment.

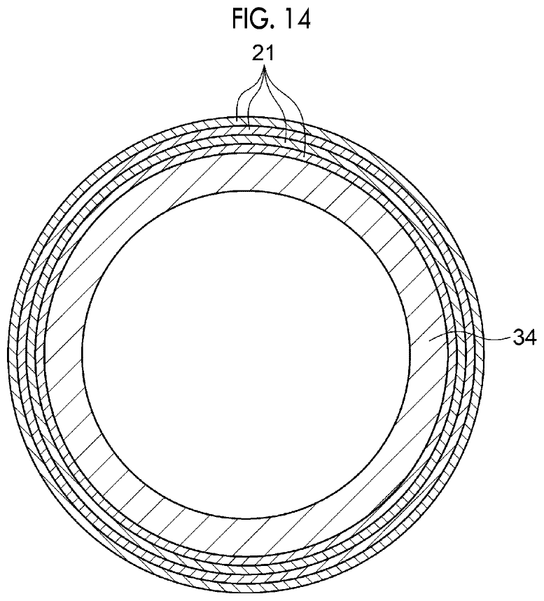

As shown in FIG. 14, the thin plate 21 includes a cylindrical portion that internally includes at least a part of the outlet pipe 34 in an axial direction. That is, the thin plate 21 is provided to extend over the entire circumference in the circumferential direction along the outer peripheral surface 341 of the outlet pipe 34.

According to such a configuration, the vibration of the turbocharger housing 2 is further damped by increasing the contact area between the thin plate 21 and the compressor housing 3, so that the vibration of the turbocharger 1 can be further suppressed.

### Fourth Embodiment

### <Configuration of Turbocharger Housing According to Fourth Embodiment of Present Disclosure>

The configuration according to the fourth embodiment can be added to the configurations of the first to third embodiments or can be an alternative form of the first to third embodiments.

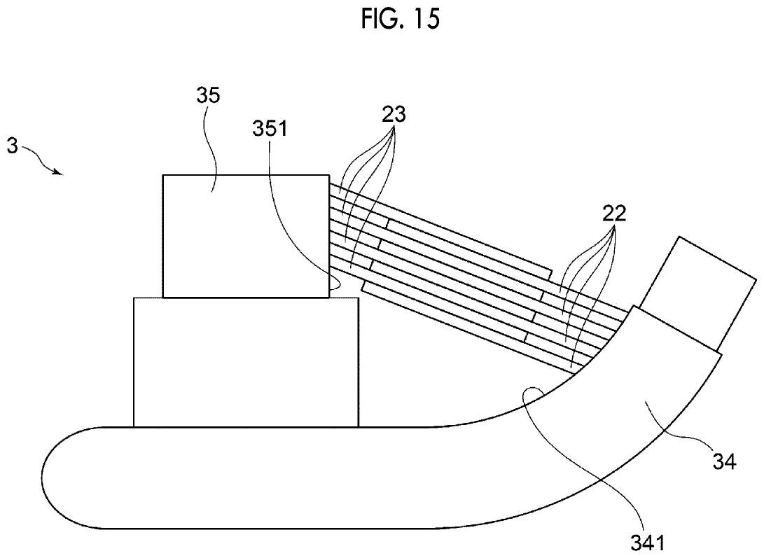

As shown in FIG. 15, the turbocharger housing 2 includes a first thin plate 22 and a second thin plate 23. The compressor housing 3 includes an outlet pipe 34 for discharging the compressed air.

In the fourth embodiment, a part of edge portions of the four first thin plates 22 is provided in the outlet pipe 34. The surface of the first thin plate 22 is provided without being in contact with the outer peripheral surface 341 of the outlet pipe 34. The first thin plate 22 can be attached to the outlet pipe 34 by any method, such as adhesion. In addition, a part of edge portions of the four second thin plates 23 is fixed to a portion other than the outlet pipe 34 in the compressor housing 3, for example, an inlet pipe 35 for introducing air. The surface of the second thin plate 23 is provided without being in contact with a surface 351 of the inlet pipe 35. It is preferable that a portion other than the outlet pipe 34 in the compressor housing 3 in which a part of the edge portion of the second thin plate 23 is fixed is a portion in which the vibration is smaller than that of the outlet pipe 34. The second thin plate 23 can be attached to a portion other than the outlet pipe 34 in the compressor housing 3 by any method, such as adhesion. In the fourth embodiment, a case where four first thin plates 22 and four second thin plates 23 are provided will be described. However, the number of the first thin plates 22 and the second thin plates 23 may be one, or may be any number of two or more

The first thin plate 22 and the second thin plate 23 are provided to be alternately positioned in a thickness direction, and the first thin plate 22 and the second thin plate 23 adjacent to each other are provided to be in contact with each other. In the fourth embodiment, the first thin plates 22 and the second thin plates 23 are provided so that each of the first thin plates 22 and each of the second thin plates 23 are in contact with each other with an area of each of the first thin plates 22 and an area of each of the second thin plates 23 being half or more of the area of each of the first thin plates 22 and the area of each of the second thin plates 23. However, the first thin plates 22 and the second thin plates 23 may be provided so that at least a part of each of the first thin plates 22 and at least a part of each of the second thin plates 23 are in contact with each other.

### <Operation of Turbocharger According to Fourth Embodiment of Present Disclosure>

Next, the operation of the turbocharger according to the fourth embodiment of the present disclosure will be described. The operation of the turbocharger 1 is the same as the operation described in the first embodiment. Therefore, vibration may also occur in the turbocharger 1 according to the fourth embodiment.

In the turbocharger 1, the vibration of the outlet pipe 34 is the largest. In the turbocharger housing 2 according to the present disclosure, a part of the edge portion of the first thin plate 22 and a part of the edge portion of the second thin plate 23 are respectively fixed to the outlet pipe 34 in which the vibration is large and to a portion other than the outlet pipe 34 in which the vibration is small. Since the degree of vibration of the outlet pipe 34 and the portion other than the outlet pipe 34 is different, the first thin plate 22 provided in the outlet pipe 34 and the second thin plate 23 provided in the portion other than the outlet pipe 34 slide with each other, and friction occurs, so that the vibration of the turbocharger housing 2 is damped, and thus the vibration of the turbocharger 1 can be suppressed.

### Fifth Embodiment

### <Configuration of Turbocharger Housing According to Fifth Embodiment of Present Disclosure>

The configuration according to the fifth embodiment can be added to the configurations of the first to fourth embodiments or can be an alternative form of the configurations of the first to fourth embodiments.

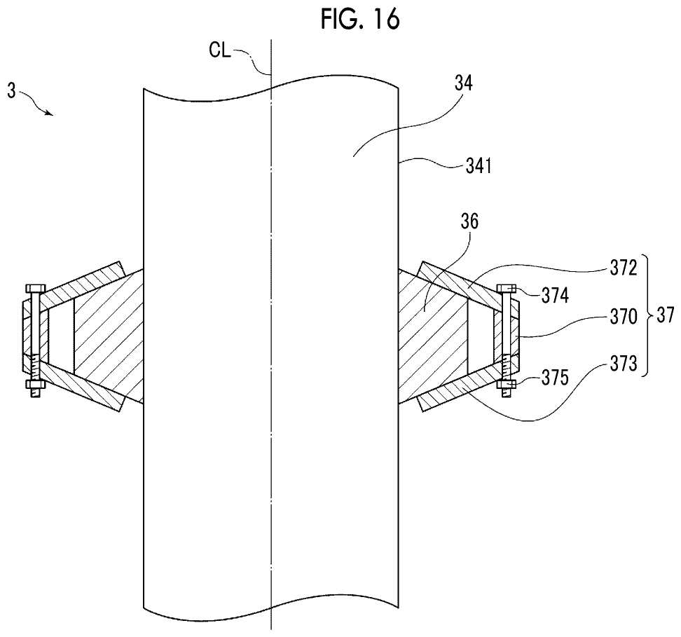

As shown in FIG. 16, an annular portion 36 is provided in the outlet pipe 34 of the compressor housing 3 to protrude with respect to the outer peripheral surface 341 of the outlet pipe 34 and to extend in an annular shape in a circumferential direction of the outer peripheral surface 341. An axis of the outlet pipe 34 is configured to coincide with an axis CL of the annular portion 36.

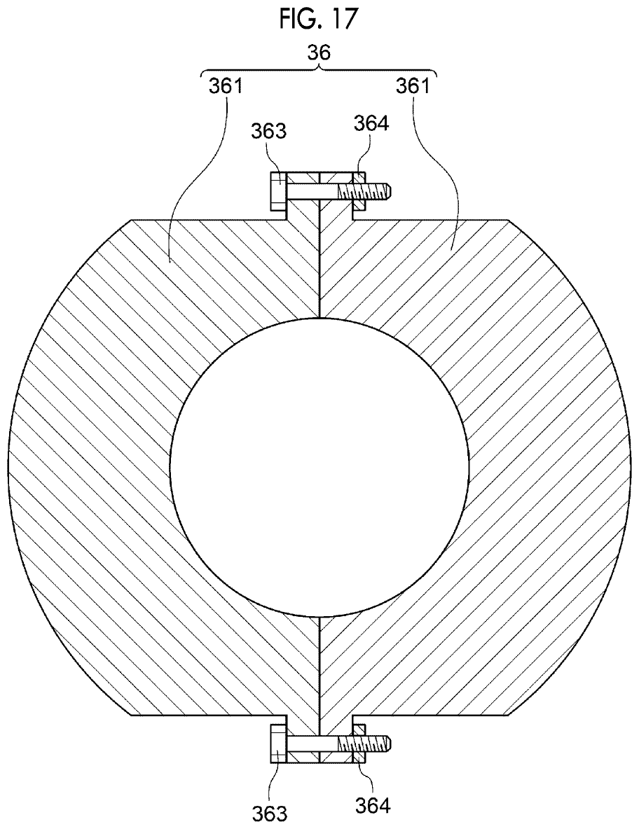

In the fifth embodiment, the annular portion 36 is configured separately from the outlet pipe 34. As shown in FIG. 17, the annular portion 36 is composed of two members 361. The two members 361 are configured to extend in an annular shape with respect to a circumferential direction of the outlet pipe 34 and to cover half of the outlet pipe 34 in the circumferential direction. The two members 361 are fastened by a bolt 363 and a nut 364, so that the annular portion 36 is fixed to the outer peripheral surface 341 of the outlet pipe 34.

As shown in FIG. 16, the annular portion 36 is configured such that the length of the annular portion 36 in the axial direction decreases toward a radial outer side of the annular portion 36. That is, the annular portion 36 has a tapered shape that becomes thinner toward the radial outer side in a cross section cut by a plane including the axis CL.

As shown in FIG. 16, an outer ring member 37 is supported on the radial outer side of the annular portion 36 and is configured to be slidable in a radial direction of the annular portion 36 with respect to the annular portion 36. An axis of the outer ring member 37 is configured to coincide with the axis CL of the annular portion 36. The outer ring member 37 is configured with a main body member 370, a downstream member 372, and an upstream member 373.

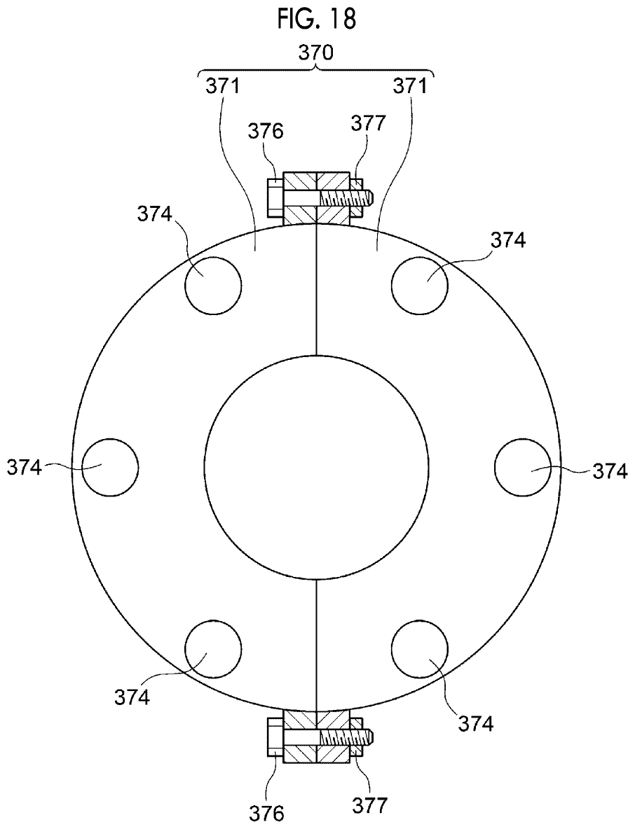

The main body member 370 is configured to extend in an annular shape in a circumferential direction of the annular portion 36. As shown in FIG. 18, the main body member 370 is configured to include two members 371. The two members 371 are configured to extend in an annular shape in the circumferential direction of the annular portion 36 and to cover half of the annular portion 36 in the circumferential direction.

As shown in FIG. 16, the downstream member 372 and the upstream member 373 are configured to extend in an annular shape with respect to the circumferential direction of the annular portion 36 and to cover half of the annular portion 36 in the circumferential direction. The downstream member 372 and the upstream member 373 are provided to protrude inward in the circumferential direction with respect to the main body member 370. The main body member 370, the downstream member 372, and the upstream member 373 are fastened by the bolt 374 and the nut 375. A plurality of bolts 374 and nuts 375 are provided at intervals in a circumferential direction of the outer ring member 37. The intervals in the circumferential direction may be equal intervals or may be different intervals. As shown in FIG. 18, the two members 371 are fastened by bolts 376 and nuts 377, so that the outer ring member 37 is supported on the radial outer side of the annular portion 36.

### <Operation of Turbocharger According to Fifth Embodiment of Present Disclosure>

Next, the operation of the turbocharger according to the fifth embodiment of the present disclosure will be described. The operation of the turbocharger 1 is the same as the operation described in the first embodiment. Therefore, vibration may also occur in the turbocharger 1 according to the fifth embodiment.

In the turbocharger 1, the vibration of the outlet pipe 34 is the largest. According to the turbocharger housing 2 of the present disclosure, the outer ring member 37 is supported on the radial outer side of the annular portion 36 and is configured to be slidable in the radial direction with respect to the annular portion 36. Therefore, in a case where vibration occurs in the outlet pipe 34, the outer ring member 37 slides relative to the annular portion 36, and friction occurs between the downstream member 372 and the annular portion 36 and between the upstream member 373 and the annular portion 36, so that the vibration of the turbocharger housing 2 is damped, and thus the vibration of the turbocharger 1 can be suppressed.

In the turbocharger housing 2 according to the present disclosure, the annular portion 36 is configured to be shorter in the axial direction toward the radial outer side. In a case where such a configuration is not adopted, it is difficult to adjust the height of the outer ring member 37 in the axial direction of the annular portion 36 such that the contact load between the annular portion 36 and the outer ring member 37 becomes an appropriate value. According to such a configuration, when the outer ring member 37 slides in the radial direction with respect to the annular portion 36, the contact load between the annular portion 36 and the outer ring member 37 becomes an appropriate value at a predetermined radial position. Therefore, it is not necessary to adjust the outer ring member 37 to the height of the annular portion 36 in the axial direction, and the outer ring member 37 can be easily designed.

In the fifth embodiment, the annular portion 36 is configured separately from the outlet pipe 34. However, the annular portion 36 may be configured integrally with the outlet pipe 34. However, when the annular portion 36 is configured to be separate from the outlet pipe 34, the outer ring member 37 slides relative to the annular portion 36. In this manner, when the annular portion 36 is worn due to friction occurring between the annular portion 36 and the outer ring member 37, only the annular portion 36 needs to be replaced with a new component, and the cost required for repairing the compressor housing 3 can be reduced.

The present disclosure is not limited to the above-described embodiments, and also includes a form in which modifications are added to the above-described embodiments or a form in which the embodiments are combined with each other as appropriate.

The contents described in the above embodiments are understood as follows, for example.
(1) A turbocharger housing (2) according to one aspect includes: a compressor housing (3) in which a first communication hole (31) is formed; a bearing housing (4) in which a second communication hole (41) is formed; a first connection part (32) provided in the compressor housing (3) to extend along an outer side in a circumferential direction of the first communication hole (31); a second connection part (42) provided in the bearing housing (4) to extend along an outer side in a circumferential direction of the second communication hole (41); a first fastening member (6) that fastens the first connection part (32) and the second connection part (42) to each other; and at least one annular first plate member (7) that is provided on at least one of the first connection part (32) or the second connection part (42) by the first fastening member (6) to be slidable relative to at least one of the first connection part (32) or the second connection part (42).

According to the turbocharger housing according to the present disclosure, the at least one annular first plate member is provided on at least one of the first connection part or the second connection part by the first fastening member to be slidable relative to at least one of the first connection part or the second connection part. Therefore, in a case where vibration occurs in the compressor housing or the bearing housing, the first plate member slides relative to the first connection part or the second connection part, and friction occurs, so that the vibration of the turbocharger housing is damped, and thus the vibration of the turbocharger can be suppressed.
(2) The turbocharger housing (2) according to another aspect is the turbocharger housing according to (1), in which the at least one first plate member (7) is provided to be slidable relative to the first connection part (32) on a side opposite to the second connection part (42) with respect to the first connection part (32).

According to such a configuration, at least one annular first plate member is provided at the first connection part by the first fastening member to be slidable relative to the first connection part. Therefore, in a case where vibration occurs in the compressor housing or the bearing housing, the first plate member slides relative to the first connection part, and friction occurs, so that the vibration of the turbocharger housing is damped, and thus the vibration of the turbocharger can be suppressed.
(3) The turbocharger housing (2) according to still another aspect is the turbocharger housing according to (1) or (2), in which the at least one first plate member (7) is provided to be slidable relative to the second connection part (42) on a side opposite to the first connection part (32) with respect to the second connection part (42).

According to such a configuration, at least one annular first plate member is provided at the second connection part by the first fastening member to be slidable relative to the second connection part. Therefore, in a case where vibration occurs in the compressor housing or the bearing housing, the first plate member slides relative to the second connection part, and friction occurs, so that the vibration of the turbocharger housing is damped, and thus the vibration of the turbocharger can be suppressed.
(4) The turbocharger housing (2) according to still another aspect is the turbocharger housing according to (1), in which the at least one first plate member (7) is provided between the first connection part (32) and the second connection part (42).

According to such a configuration, at least one annular first plate member is provided on at least one of the first connection part or the second connection part by the first fastening member to be slidable relative to at least one of the first connection part or the second connection part. Therefore, in a case where vibration occurs in the compressor housing or the bearing housing, the first plate member slides relative to the first connection part or the second connection part, or both of the first connection part and the second connection part, and friction occurs, so that the vibration of the turbocharger housing is damped, and thus the vibration of the turbocharger can be suppressed.
(5) The turbocharger housing (2) according to still another aspect is the turbocharger housing according to any one of (1) to (4), in which the at least one first plate member (7) includes a plurality of first plate members (7), and the first plate members (7) adjacent to each other are provided to be slidable relative to each other.

According to such a configuration, in a case where vibration occurs in the compressor housing or the bearing housing, the first plate members adjacent to each other slide relative to each other, and friction occurs between the first plate members adjacent to each other, so that the vibration of the turbocharger housing is further damped, and thus the vibration of the turbocharger can be further suppressed.
(6) The turbocharger housing (2) according to still another aspect is the turbocharger housing according to any one of (1) to (5), the turbocharger housing (2) further including: a third connection part (47) provided in the bearing housing (4) to extend along an outer side in a circumferential direction of a third communication hole (46) formed in the bearing housing (4); a turbine housing (5) in which a fourth communication hole (51) is formed; a fourth connection part (52) provided in the turbine housing (5) to extend along an outer side in a circumferential direction of the fourth communication hole (51) formed in the turbine housing (5); a second fastening member (8) that fastens the third connection part (47) and the fourth connection part (52) to each other; and at least one second plate member (9) having an annular shape and provided on at least one of the third connection part (47) or the fourth connection part (52) by the second fastening member (8) to be slidable relative to at least one of the third connection part (47) or the fourth connection part (52).

According to such a configuration, at least one second plate member having an annular shape is provided on at least one of the third connection part or the fourth connection part by the second fastening member to be slidable relative to at least one of the third connection part or the fourth connection part. Therefore, in a case where vibration occurs in the bearing housing or the turbine housing, the second plate member slides relative to the third connection part or the fourth connection part, and friction occurs, so that the vibration of the turbocharger housing is damped, and thus the vibration of the turbocharger can be suppressed.
(7) The turbocharger housing (2) according to still another aspect is the turbocharger housing according to (6), in which the at least one second plate member (9) is provided to be slidable relative to the third connection part (47) on a side opposite to the fourth connection part (52) with respect to the third connection part (47).

According to such a configuration, at least one second plate member having an annular shape is provided at the third connection part by the second fastening member to be slidable relative to the third connection part. Therefore, in a case where vibration occurs in the bearing housing or the turbine housing, the second plate member slides relative to the third connection part, and friction occurs, so that the vibration of the turbocharger housing is damped, and thus the vibration of the turbocharger can be suppressed.
(8) The turbocharger housing (2) according to still another aspect is the turbocharger housing according to (6) or (7), in which the at least one second plate member (9) is provided to be slidable relative to the fourth connection part (52) on a side opposite to the third connection part (47) with respect to the fourth connection part (52).

According to such a configuration, at least one second plate member having an annular shape is provided at the fourth connection part by the second fastening member to be slidable relative to the fourth connection part. Therefore, in a case where vibration occurs in the bearing housing or the turbine housing, the second plate member slides relative to the fourth connection part, and friction occurs, so that the vibration of the turbocharger housing is damped, and thus the vibration of the turbocharger can be suppressed.
(9) The turbocharger housing (2) according to still another aspect is the turbocharger housing according to (6), in which the at least one second plate member (9) is provided between the third connection part (47) and the fourth connection part (52).

According to such a configuration, at least one second plate member having an annular shape is provided on at least one of the third connection part or the fourth connection part by the second fastening member to be slidable relative to at least one of the third connection part or the fourth connection part. Therefore, in a case where vibration occurs in the bearing housing or the turbine housing, the second plate member slides relative to the third connection part or the fourth connection part, or both of the third connection part and the fourth connection part, and friction occurs, so that the vibration of the turbocharger housing is damped, and thus the vibration of the turbocharger can be suppressed.
(10) The turbocharger housing (2) according to still another aspect is the turbocharger housing according to any one of (6) to (9), in which the at least one second plate member (9) includes a plurality of second plate members (9), and the second plate members (9) adjacent to each other are provided to be slidable relative to each other.

According to such a configuration, in a case where vibration occurs in the bearing housing or the turbine housing, the second plate members adjacent to each other slide relative to each other, and friction occurs in the second plate members adjacent to each other, so that the vibration of the turbocharger housing is further damped, and thus the vibration of the turbocharger can be further suppressed.
(11) A turbocharger (1) according to one aspect includes the turbocharger housing according to any one of (1) to (10).

According to the turbocharger of the present disclosure, since any of the above-described turbocharger housings is provided, it is possible to suppress vibration of the turbocharger.
(12) The turbocharger housing (2) according to still another aspect includes: the compressor housing (3) that includes an outlet pipe (34) for discharging compressed air; and a thin plate (21) that is provided by fastening members (211, 212) in each of the outlet pipe (34) and another portion to be slidable relative to the compressor housing (3).

In the turbocharger, the vibration of the outlet pipe is the largest. According to the turbocharger housing according to the present disclosure, the thin plate is provided by the fastening member in each of the outlet pipe and the other portion to be slidable relative to the compressor housing. Therefore, in a case where vibration occurs in the turbocharger housing, the thin plate slides relative to the compressor housing, and friction occurs, so that the vibration of the turbocharger housing is damped, and thus the vibration of the turbocharger can be suppressed.
(13) The turbocharger housing (2) according to still another aspect is the turbocharger housing according to (12), in which the thin plate (21) is provided to extend along the outer peripheral surface (341) of the outlet pipe (34).

According to such a configuration, the thin plate is provided to extend along the outer peripheral surface of the outlet pipe. Therefore, the vibration of the turbocharger housing is further damped by increasing the contact area between the thin plate and the compressor housing, and thus the vibration of the turbocharger can be further suppressed.
(14) The turbocharger housing (2) according to still another aspect is the turbocharger housing according to (12) or (13), in which the thin plate (21) includes a cylindrical portion that internally includes at least a part of the outlet pipe (34).

According to such a configuration, the thin plate extends over the entire circumference in the circumferential direction along the outer peripheral surface of the outlet pipe. Therefore, the vibration of the turbocharger housing is further damped by increasing the contact area between the thin plate and the compressor housing, and thus the vibration of the turbocharger can be further suppressed.
(15) A turbocharger housing (2) according to still another aspect includes: a compressor housing (3) that includes an outlet pipe (34) for discharging compressed air; at least one first thin plate (22); and at least one second thin plate (23), in which a part of an edge portion of the at least one first thin plate (22) is fixed to the outlet pipe (34), a part of an edge portion of the at least one second thin plate (23) is fixed to a portion other than the outlet pipe (34) in the compressor housing (3), and each of the at least one first thin plate (22) and each of the at least one second thin plate (23) are in contact with each other.

In the turbocharger, the vibration of the outlet pipe is the largest. In the turbocharger housing according to the present disclosure, a part of an edge portion of the first thin plate and a part of an edge portion of the second thin plate are respectively fixed to the outlet pipe having a large vibration and to a portion other than the outlet pipe having a small vibration. Since the degree of vibration of the outlet pipe and the degree of vibration of a portion other than the outlet pipe are different, the first thin plate fixed to the outlet pipe and the second thin plate fixed to the portion other than the outlet pipe slide with each other, and friction occurs, so that the vibration of the turbocharger housing is damped, and thus the vibration of the turbocharger can be suppressed.
(16) A turbocharger housing (2) according to still another aspect includes: a compressor housing (3) that includes an outlet pipe (34) for discharging compressed air; an annular portion (36) that protrudes with respect to an outer peripheral surface (341) of the outlet pipe (34) and that extends in an annular shape in a circumferential direction of the outer peripheral surface (341); and an outer ring member (37) that is supported on a radial outer side of the annular portion (36) and that is configured to be slidable in a radial direction with respect to the annular portion (36).

In the turbocharger, the vibration of the outlet pipe is the largest. According to the turbocharger housing of the present disclosure, the outer ring member is supported on the radial outer side of the annular portion and is configured to be slidable in the radial direction with respect to the annular portion. Therefore, in a case where vibration occurs in the outlet pipe, the outer ring member slides relative to the annular portion, and friction occurs, so that the vibration of the turbocharger housing is damped, and thus the vibration of the turbocharger can be suppressed.
(17) The turbocharger housing (2) according to still another aspect is the turbocharger housing according to (16), in which the annular portion (36) is configured to be shorter in an axial direction of the annular portion (36) toward the radial outer side.

According to such a configuration, the annular portion is configured to be shorter in the axial direction of the annular portion toward the radial outer side. In a case where such a configuration is not adopted, it is difficult to adjust the height of the outer ring member in the axial direction of the annular portion such that the contact load between the annular portion and the outer ring member has an appropriate value. According to such a configuration, when the outer ring member slides in the radial direction with respect to the annular portion, the contact load between the annular portion and the outer ring member becomes an appropriate value at a predetermined radial position. Therefore, it is not necessary to adjust the outer ring member to the height of the annular portion in the axial direction, and the outer ring member can be easily designed.

### REFERENCE SIGNS LIST

1: turbocharger
2: turbocharger housing
3: compressor housing
4: bearing housing
5: turbine housing
6: first fastening member
7: first plate member
8: second fastening member
9: second plate member
10: engine
11: shaft
13: impeller
14: bearing
15: turbine rotor
16: intake air channel
17: exhaust channel
21: thin plate
22: first thin plate
23: second thin plate
31: first communication hole
32: first connection part
33: hole
34: outlet pipe
35: inlet pipe
36: annular portion
37: outer ring member
41: second communication hole
42: second connection part
43: hole
46: third communication hole
47: third connection part
48: hole
51: fourth communication hole
52: fourth connection part
53: hole
61: bolt
62: nut
63: clamp
71: gasket
72: gasket
81: bolt
82: nut
83: clamp
211: fastening member
212: fastening member
341: outer peripheral surface
351: surface
361: member
363: bolt
364: nut
370: main body member
371: member
372: downstream member
373: upstream member
374: bolt
375: nut
376: bolt
377: nut

1. A turbocharger housing comprising:
a compressor housing in which a first communication hole is formed;
a bearing housing in which a second communication hole is formed;
a first connection part provided in the compressor housing to extend along an outer side in a circumferential direction of the first communication hole;
a second connection part provided in the bearing housing to extend along an outer side in a circumferential direction of the second communication hole;
a first fastening member that fastens the first connection part and the second connection part to each other; and
at least one first plate member having an annular shape and provided on at least one of the first connection part or the second connection part by the first fastening member to be slidable relative to at least one of the first connection part or the second connection part.

2. The turbocharger housing according to claim 1,
wherein the at least one first plate member is provided to be slidable relative to the first connection part on a side opposite to the second connection part with respect to the first connection part.

3. The turbocharger housing according to claim 1,
wherein the at least one first plate member is provided to be slidable relative to the second connection part on a side opposite to the first connection part with respect to the second connection part.

4. The turbocharger housing according to claim 1,
wherein the at least one first plate member is provided between the first connection part and the second connection part.

5. The turbocharger housing according to claim 1,
wherein the at least one first plate member includes a plurality of first plate members, and the first plate members adjacent to each other are provided to be slidable relative to each other.

6. The turbocharger housing according to claim 1, further comprising:
a third connection part provided in the bearing housing to extend along an outer side in a circumferential direction of a third communication hole formed in the bearing housing;
a turbine housing in which a fourth communication hole is formed;
a fourth connection part provided in the turbine housing to extend along an outer side in a circumferential direction of the fourth communication hole formed in the turbine housing;
a second fastening member that fastens the third connection part and the fourth connection part to each other; and
at least one second plate member having an annular shape and provided on at least one of the third connection part or the fourth connection part by the second fastening member to be slidable relative to at least one of the third connection part or the fourth connection part.

7. The turbocharger housing according to claim 6,
wherein the at least one second plate member is provided to be slidable relative to the third connection part on a side opposite to the fourth connection part with respect to the third connection part.

8. The turbocharger housing according to claim 6,
wherein the at least one second plate member is provided to be slidable relative to the fourth connection part on a side opposite to the third connection part with respect to the fourth connection part.

9. The turbocharger housing according to claim 6,
wherein the at least one second plate member is provided between the third connection part and the fourth connection part.

10. The turbocharger housing according to claim 6, wherein the at least one second plate member includes a plurality of second plate members, and the second plate members adjacent to each other are provided to be slidable relative to each other.

11. A turbocharger comprising:
the turbocharger housing according to claim 1.
